(19) United States
(12) Patent Application Publication
(10) Pub. No.: US 2005/0161505 A1
(43) Pub. Date: Jul. 28, 2005

(54) Automobile/motorcycle license identification label

(76) Inventors: Debra Lynne Yin, Fountain Hills, AZ (US); Philip C.S. Yin, Fountain Hills, AZ (US)

Correspondence Address: Debra L. Yin, 14219 N. Desert Flower Dr., Fountain Hills, AZ, 85268, US

(21) Appl. No.: 10/640,542

(22) Filed: Jan. 26, 2004

(51) Int. Cl. G07B 15/02

(52) U.S. Cl. 235/384

(57) ABSTRACT

An automobile/motorcycle license identification label and a method for producing it are disclosed. The system utilizes a conventional label with barcoding which includes information that identifies the vehicle identification number (VIN), the license registration information and insurance information, perceptible with the use of a laser decoder utilized by Department of Public Safety (DPS) officers. This is meant to replace the current metal license plate on automobiles and motorcycles.

### BACKGROUND OF THE INVENTION

This invention relates to the identification of an automobile/motorcycle using an automobile/motorcycle license label. This invention relates in particular to an automobile/motorcycle license label. The method and apparatus for the production of such label, as well as a method and apparatus for reading and retrieving the barcoded information for the purpose of checking this information would be used from already developed inventions/processes.

### DESCRIPTION OF THE PRIOR LICENSE PLATES

With the current automobile/motorcycle license plates, it is necessary for all auto/motorcycle manufacturers to produce a bracket, space, lights and wiring for license plates. It is also necessary with the current system, that each state produce the plates, customize them with color/graphics, develop a numbering system and store them for disbursement to licensees. It is also necessary for each state to produce renewal tags, notify licensees of renewal dates and mail/disperse the tags.

### SUMMARY OF THE INVENTION

With the stated automobile/motorcycle license identification label, the information that is currently being stored by MVD on an automobile/motorcycle's registration would be transferred in a barcode on a label which would be affixed to the vehicle in a designated location. The renewal and insurance information would be updated in the computer database so that as the barcode is read, the updated information is displayed on the screen for the DPS officer or official who is reading the label.

This automobile/motorcycle license label would:

Eliminate the costly production, development, storage and mailing of metal license plates.

Eliminate the costly engineering and design that auto manufacturers must do to meet the requirements of placing plates on automobiles/motorcycles.

Provide for a streamlined, clean appearance on vehicles.

Eliminate the expense to collect and discard of old plates.

Eliminate the production of license renewal tags.

Eliminate the need for DPS officer to manually enter license # to retrieve information.

Eliminate the need for DPS officer to stop vehicle and ask to see registration and insurance documentation.

Provide for more accurate and complete information to DPS officers.

Provide for security and privacy of information since the automobile/motorcycle license # would not be readable by the unaided eye.

Eliminate the theft of a license plate, as the label would not be reattachable once removed.

Eliminate a safety problem when metal plates fly off while driving or in an accident.

### BRIEF DESCRIPTION OF THE DRAWINGS

The foregoing and other objects, features and advantages of the invention will be apparent from the following more particular description of the preferred embodiments of the invention, as illustrated in the accompanying drawings.

In the drawings:

FIG. 1 is a view of an automobile/motorcycle license label having stored information in a barcode format.

FIG. 2 is a sample device for making the automobile/motorcycle license identification label barcode having stored the VIN #, license registration data (i.e., license #, renewal data, lien status, etc.), title information and auto insurance information/expiration date.

FIG. 3 is a measuring laser scanner device for reading the license label barcode.

FIG. 4 is the monitor for displaying the information on the label for DPS officers.

### DETAILED DESCRIPTION OF THE INVENTION

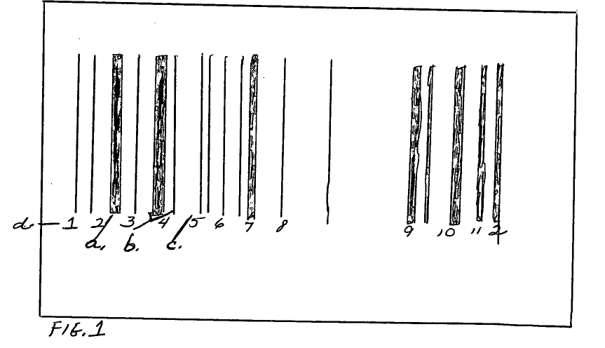

With reference to FIG. 1, the data in a bar code format is a reference number which the computer uses to look up associated computer disk record(s) which contain the descriptive data and other pertinent information.

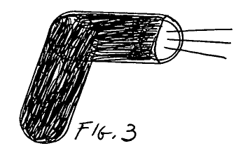

The bar code will have only ID data in it; the ID data is used by the computer to look up all the pertinent detailed data associated with the ID data This stored data is then transmitted to the DPS officer for information purposes and verification upon reading with the laser gun as noted in FIG. 3.

A bar code is a series of varying width vertical lines (a.)(called bars) and (c.)spaces. Bars and spaces together are named (b.)“elements”. There are different combinations of the bars and spaces which represent different characters.

The low-density barcode will contain up-to-date data which is retrieved and transmitted by the laser reader through the central computer system for retrieval and then displayed on a monitor for the DPS officer. This data includes, but is not limited to, the VIN#, registration information, title information, lienholder information and automobile insurance information/expiration date.

As an example, the first digit (d.) could represent the state of issue, digits #2-6 could represent the particular VIN # to provide the specific automobile/motorcycle title and registration information, make and year of car, digits #7-11 could represent the driver's license of the registered owner and insurance information. The last digit is the check-digit.

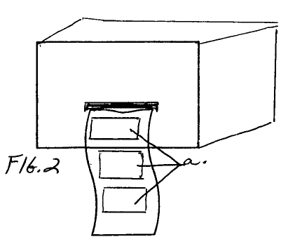

With reference to FIG. 2, the barcode could be printed on a (a) white label sized to hold the data listed in FIG. 1 description, but would be a standard size in all 50 states. Each state would have the ability to customize their label with, but not limited to, their state name, logo, colors, etc. The label would be clear coated with plastic to preserve its integrity. The label would adhere to the rear of the vehicle in a designated area.

According to FIG. 3, a laser scanner would be used to read and transmit the data on the barcode. The laser beam is invisible and not noticeable to the human eye. Checking of the automobile is unnoticed by the driver, a passenger or a passer-by. It can also be checked at a long distance and while the vehicle(s) are traveling. High intensity IR lasers are highly efficient, readily available and can be designed for this purpose. The laser scanner would be pointed on the label and scanned for retrieval of the data.

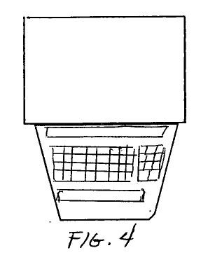

According to FIG. 4, the monitor would be located in the police vehicle or would be a portable unit. The data would be displayed in a format that is easily read and provides up-to-date data from the main computer station.

It is understood that the embodiments listed here may be preferred, but the invention is not limited to these precise forms of production, design, retrieval and use, and that a variety of changes may be made without departing from the scope of this invention.

1. In an identification system for an automobile/motorcycle, the improvement comprising a barcoded license label which contains coded information not decodable with the unaided human eye and which can be affixed to the automobile/motorcycle.

2. The automobile/motorcycle license label according to claim 1, wherein said information label is applied to rear of vehicle on a prepared and allocated surface.

3. The automobile/motorcycle license label according to claim 1, wherein said barcoded information includes, but is not limited to, the VIN # (vehicle identification #), license registration data (i.e., license #, renewal data, lien status, etc.), title ownership and auto insurance information/expiration date.

4. The automobile/motorcycle license label according to claim 3, wherein said coded information is distributed on a label sized to hold said information clearly.

5. The automobile/motorcycle license label according to claim 3, wherein an area is designated on the vehicle by the licensing government as the location to affix the label.

6. The automobile/motorcycle license label according to claim 3, wherein said label is produced with a protective coating and adhesive backing.

7. A method for producing an automobile/motorcycle license label with barcoding that contains the information in claim 3, in such a way as to be recognizable and readable by the aided eye only.

8. The method, according to claim 7, wherein providing said surface with said coded information comprises the steps of entering or downloading said information into a computer in the Motor Vehicles Department (MVD)and available to be immediately transmitted to DPS officers.

9. An apparatus for producing an automobile license label comprising, in combination, a label barcode system and an input or download device for transferring information into a readable barcode.

10. A method for retrieval of the barcoded information on an automobile license label, said coded information being stored and updated by the MVD, reading and converting said information to an image that can be evaluated visually.

11. An apparatus for the retrieval of the barcoded information in an automobile/motorcycle license label, said coded information read by:
(a) a measuring laser scanner for the reading of barcodes,
(b) an optical system for receiving the measuring laser light,
(c) a monitor for the visual representation of the data.
